(19) United States
(12) Patent Application Publication
(10) Pub. No.: US 2010/0186899 A1
(43) Pub. Date: Jul. 29, 2010

(54) THERMOPLASTIC MANDRELS FOR COMPOSITE FABRICATION

(75) Inventors: Aubrey G. Jackson, Costa Mesa, CA (US); John D. Maligie, Long Beach, CA (US)

Correspondence Address: FOLEY & LARDNER, 555 South Flower Street, SUITE 3500, LOS ANGELES, CA, 90071-2411, US

(73) Assignee: AIRTECH INTERNATIONAL, INC.

(21) Appl. No.: 12/687,258

(22) Filed: Jan. 14, 2010

Related U.S. Application Data
(60) Provisional application No. 61/144,942, filed on Jan. 15, 2009.

(51) Int. Cl. B32B 37/10; B29C 47/06

(52) U.S. Cl. 156/382; 156/349; 264/209.1

(57) ABSTRACT

A mandrel assembly that includes an elongated hollow structure comprising a thermoplastic material that is extrudable having a first end and a second end. A first end cap attached to the first end. A vent tube attached to the first end cap, the vent tube extending from the first end cap. A second end cap attached to the second end. The mandrel assembly adapted to shape and form a composite structure in or outside an autoclave.

### CROSS-REFERENCE TO RELATED PATENT APPLICATIONS

This application claims priority from Provisional Application No. 61/144,942, filed Jan. 15, 2009, incorporated herein by reference in its entirety.

### FIELD OF THE DISCLOSURE

Embodiments of the present invention relate to the process for fabricating a mandrel used in the fabrication of composite articles by fabrication techniques such as, but not limited to, fiber placement, tape laying, hand lay-up, resin infusion and resin transfer molding processes cured both in and out of an autoclave.

### BACKGROUND OF THE DISCLOSURE

Composite structures can be formed into various shapes by using a variety of materials. Mandrels may be used to shape composite structures. Composite structures can be designed and fabricated in various shapes, such as but not limited to, “hat” sections, “T” or “J” shaped stiffeners or “I” beams as part of a design. Each of the above shapes can be co-cured or co-bonded. Secondary tooling can be used to locate, support, form and apply pressure to the final product during the curing process. Mandrels of various shapes and sizes can be used to create the above mentioned shapes.

Various methods and materials have been used to fabricate mandrels. Foam can be used for a mandrel, the foam mandrel can be either sacrificial or remain in the finished composite part. Mandrels formed with metal or metal alloys have been used, but depending on the part configuration, coefficient of thermal expansion, and ease of extraction, the metal mandrels can damage the finished part. With metallic mandrels there can be complications in reaching a level of quality for a non destructing inspection (NDI result) needed for composite structures in certain structures.

Other types of mandrel materials include Butyl and Silicone rubber mandrels that are used for composite fabrication. They are used in both solid and hollow forms. Solid mandrels can be cast from liquid rubber, extruded or molded in two piece female tools. It is possible to incorporate fiberglass, Dacron or carbon fiber reinforcements into these rubber mandrels to impart strength and reduce shrinkage. These solid mandrels have drawbacks due to the difficulty of predicting actual thermal expansion in use, changing expansion properties over multiple fabrication cycles, and in some cases difficulty in extraction of the mandrel from the finished part. With silicone mandrels, there is a possibility of contamination that can have an adverse impact on secondary bonding and painting of the composite part.

Hollow rubber mandrels, on the other hand, can be fabricated by extrusion or hand lay-up in female molds. Most often these mandrels are hand laid-up and cured in a split female tool. The outer surface of the hand laid-up mandrels can be made of bonded Teflon. However, a drawback of bonded Teflon is the presence of at least one split line in the Teflon. The thin line of exposed rubber at the split line of the molds can be weakened by the resins during the composite cure process. This can significantly shorten the usable life of the rubber mandrel. The thin line of exposed rubber can also be a starting point for leaks in the mandrel, causing other defects. Due to high cost of labor needed for hand laid-up mandrels, these mandrels can be costly to use during the production process.

### SUMMARY

A mandrel assembly having an elongated hollow portion made of a thermoplastic material that is extrudable, the elongated hollow portion having closed ends. A vent tube connected to at least one closed end of the elongated hollow portion. The vent tube is configured to be in air flow communication between an interior volume of the mandrel and a volume outside the mandrel assembly.

### BRIEF DESCRIPTION OF THE DRAWINGS

FIG. 1 is a perspective view of the mandrel with end caps and vent tube.

FIG. 2 is a cross-sectional view of the mandrel of FIG. 1 with an end cap and vent.

FIG. 3 is a cross-sectional view of a trapezoidal mandrel.

FIG. 4 is a sectional view of a trapezoidal mandrel in a multilayer embodiment, showing layers of material.

FIG. 5 is a sectional view of the closed end cap bonded to the extrusion.

FIG. 6a is a sectional view of a prior art multilayer hollow rubber mandrel.

FIG. 6b is a single layer embodiment of the mandrel of FIGS. 1-5.

FIG. 7 is a perspective view of a fuselage panel co-cured stack, illustrating the position and purpose of the thermoplastic mandrel in the manufacturing process.

FIG. 8 is a sectional view of a fuselage panel co-cured stack, illustrating the position and purpose of the thermoplastic mandrel in the manufacturing process.

FIG. 9 is a sectional view of a co-cured fuselage showing the position of the thermoplastic mandrel in the composite part during cure.

FIG. 10 is a close-up sectional view of a fuselage panel, illustrating the position and purpose of the thermoplastic mandrel in the manufacturing process.

FIG. 11 is a sectional view of an example mandrel cross section.

### DETAILED DESCRIPTION OF THE DISCLOSURE

The new method utilizes a thermoplastic extrusion for the body of the mandrel. This method enables a seamless mandrel in any constant section, of any length. The mandrels can be monolayer or multilayer. For most applications the strength, vacuum integrity and release characteristics of one layer of thermoplastic material is sufficient, and polymethylpentene blends can be used as the thermoplastic material. However, in certain applications other polymers may be used, in monolayer and/or multilayer combinations. If needed, multilayer extrusions may provide added strength, vacuum integrity, chemical resistance and release characteristics. As the mandrels are extruded rather than molded, there are no constraints due to the length of the mold, oven size or press limitations. For example, oven sizes or press limitation may not be able to create panels of up to 18 meters long. However, the extruded mandrels are not limited in size and can be up to and greater than 18 meters long. The mandrel assembly includes an elongated hollow structure comprising a thermoplastic material that is extrudable having a first end and a second end.

Depending on the configuration of the end product, the basic extrusion may be closed using thermoplastic or metallic end caps. The ends can be capped with end caps using welding or bonding methods. When the end caps are used, one end is vented to allow ambient or autoclave pressure to enter the hollow mandrel and apply pressure to internal laminate surfaces during curing.

In the alternative, without the end caps, the mandrel can be sealed to the vacuum bag using sealant tape and function as an extension of the vacuum bag. In this scenario, a vent tube is not required.

Referring now to the drawings, wherein like numbers refer to like parts, the following discussion details the construction of mandrel used for the fabrication of composite parts. Specific physical dimensions are not stated as the fabrication concept may be used with mandrels of a multitude of sizes and shapes.

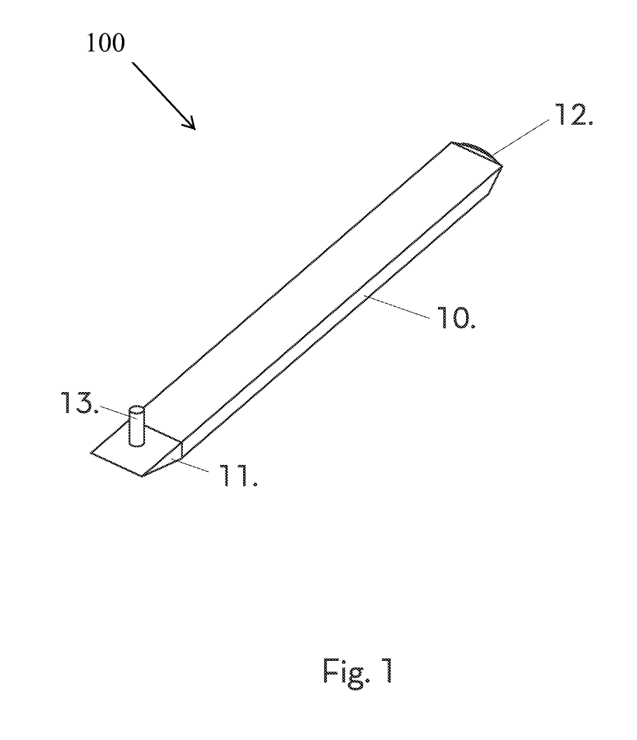

Referring to FIG. 1, FIG. 1 shows the mandrel 100 according to an example embodiment of the present invention. The mandrel 100 can include, a extruded portion 10, an end cap 11, an end cap 12 and a vent 13. The extruded portion 10 can be extruded to a desired size and shape. For an example application, the extruded portion 10 can have a trapezoidal cross section with corners radiused to meet engineering or manufacturing requirements. Side wall angles of the trapezoidal shapes can vary depending on the application and type of structure being fabricated. “Hat” or “Omega” shapes can have sidewalls and “J”, “T” and “I” shaped beam stiffeners can have at least one wall perpendicular to the base of the extrusion. Typical sizes will range between about one to about six inch cross section length, but can be of any size and shape. Other types of polymer materials can be used depending on the end user requirements, with release characteristics (surface tension of about 24 dyne/cm), chemical resistance, vacuum pressure and structural integrity properties. Those materials include, but are not limited to, polymethylpentene, polyolefins, polyamides, fluoropolymers and thermoplastic elastomers, other thermoplastic materials or mixtures that are capable of being continuously extruded. Polymethylpentene is a thermoplastic polymer that may be made of Methylpentene monomer units.

The extruded portion 10 can be made of for example, polymethylpentene, which can be continuously melted and extruded through a plurality of molds and cooled to form an extruded portion 10. The extruded portion 10 is capable of being cut into a desired shapes and sizes. The continuous extruded portion 10 can be formed of a single layer of thermoplastic material that can be of various thicknesses, such as, but not limited to about 0.020 inches to about 0.125 inches. In other embodiments, the continuously extruded portion 10 can be formed of multilayer materials that are layered to be of varying thicknesses, such as, but not limited to about 0.020 inches to about 0.125 inches. The continuous extrusion process allows the cost of the extruded portion 10 to be lower than other molded mandrels. Thus, allowing the thermoplastic mandrel to be removed after a single use, instead of requiring costly labor to clean up a used mandrel.

The polymethylpentene mandrels may be extruded using extrusion equipment that is capable of the heat up rates and material flow rates needed to extrude the thermoplastic material. Sizing dies may be used to maintain dimensional tolerances.

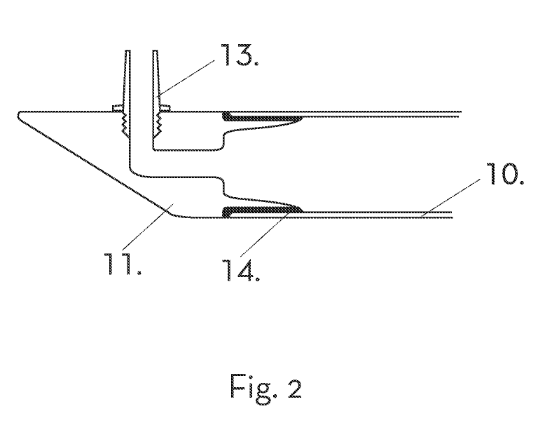

The end caps 11 and 12 can comprise similar materials as the extruded portion 10 or be formed of materials with the substantially similar coefficient of expansion to allow each part to uniformly expand or contract according to the surrounding temperature and pressure. The end caps 11 and 12 can be bonded to the extended portion 10 as shown in FIG. 2, by various attachment mechanisms. In other embodiments, the attachment materials such as, heat and pressure resistant glues, polymers, or thermoplastic materials or other bonding materials could be used for the attachment mechanism.

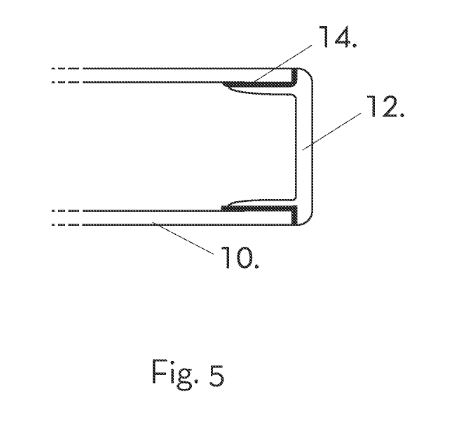

Referring again to FIG. 1, after an extruded portion 10 has been extruded and cut to length, it can be used in some applications without additional modification. In other applications, end caps 11 and 12 with a vent tube 13 can be used for leak proof performance in a vacuum bagging autoclave process. FIGS. 2 and 5 show sectional views of the extruded portion 10 with the end caps 11 and 12 bonded with adhesive layer 14. Vent tube 13 can be affixed to end cap 11 and functions to penetrate a vacuum bag used in the autoclave process. The vent tube 13 provided air flow communication between the interior volume of the hollow mandrel and the autoclave vacuum bag. A hole in the vacuum bagging material is sealed to the tube/end cap assembly using butyl rubber sealant tape or similar material.

Referring to FIG. 2, FIG. 2 shows a longitudinal cross-section of the mandrel 100 according to an example embodiment of the present invention. The vent tube 13 and end cap 11 can be formed in a single unitary body or in alternative be attached to each other. As shown in FIG. 2, the vent tube 13 can protrude in a perpendicular direction relative to the extruded portion 10, however, in other embodiments, the vent tube may be at about 30, 45 or about 60 degree angle relative to the extruded portion 10. Also shown in FIG. 2, an adhesive layer 14 forms an air tight seal between the end cap 11 and extruded portion 10. Also shown is the volume created by the interior walls of the extruded portion 10, end cap 11 and vent tube 13. The width and the length dimensions of the end cap 11 can be the substantially equal to the width and the height dimensions of the extruded portion 10.

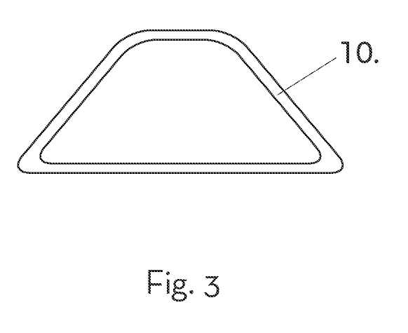

FIG. 3 shows a widthwise cross section of a single layer extruded portion 10. The single layer of the extruded portion 10 can be an extruded thermoplastic material. Various blends of polymethylpentene can be suited for high temperature processes that are used to produce composite materials, such as but not limited to carbon/epoxy, glass/epoxy, carbon/bismaleimide or the like. Composite materials are currently used in aeronautical fuselage, wings and stabilizers, and high-end performance car bodies. Thus, composite materials need to be shaped and sized accordingly. In order to create the large sizes of composite parts, large mandrels without size limitations may be used.

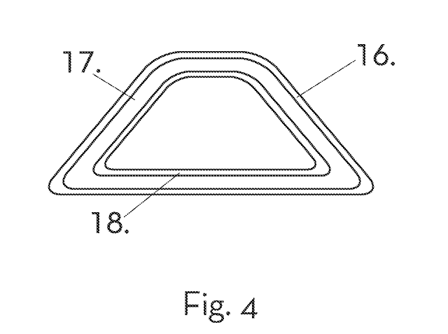

Other material combinations are possible in monolayer and multilayer constructions. One possible multilayer combination is shown in FIG. 4 where layer 16 can be Ethylene tetrafluoroethylene (ETFE), which imparts release characteristics and chemical resistance, polymethylpentene layer 17, which imparts structural strength and vacuum integrity, and nylon layer 18 which imparts additional vacuum integrity and a bondable surface. In alternative embodiments, layer 16 may be other materials, such as FEP or the like, that can impart greater release characteristics and chemical resistance. FEP is one such material.

Referring to FIG. 5, FIG. 5 shows the extruded portion 10 with the end cap 12 bonded with adhesive layer 14 to one end of the extruded portion 10 to create an air tight seal between the hollow cavity of the extruded portion 10 and outside the end cap 12. In alternative, end cap 12 may be used on both ends of the extruded portion with a vent 13 attached to one of the end caps 12. In an alternative embodiment, the extruded portion 10 may be used as a mandrel without any end caps 11, 12 or vent tube 13.

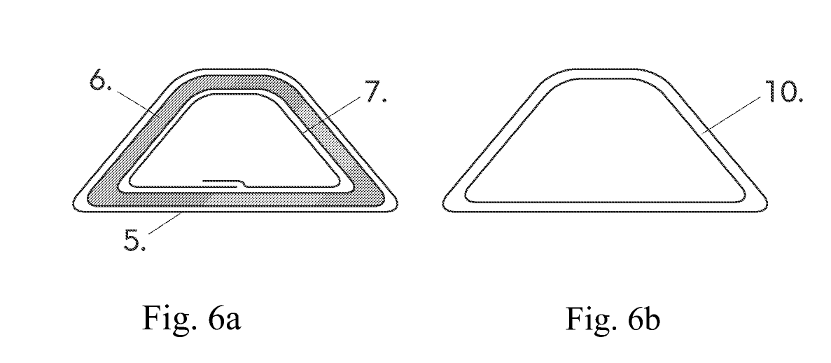

Referring to FIG. 6a, FIG. 6a is a representation of the an embodiment of the a hollow silicone mandrel compared to FIG. 6b that shows a monolayer polymethylpentene section 10. The silicone mandrel is made of an etched fluorinated ethylene propylene (FEP) layer 5 that can be cured and bonded together with silicone rubber 6 and fiberglass layer 7. The hollow silicone embodiment with the FEP outer layer requires manual labor, and represents the high cost requiring re-use of the hollow silicone mandrel. However, embodiments of the present invention are cheap enough to be disposable or recyclable after a single use.

Referring to FIG. 6b, FIG. 6b shows a single layer extrusion portion 10 that may be used as part of a mandrel 100. Since the single layer extrusion portion 10 can be continuously extruded from one material, it is cheaper and faster to manufacture compared to the mandrel shown in FIG. 6a.

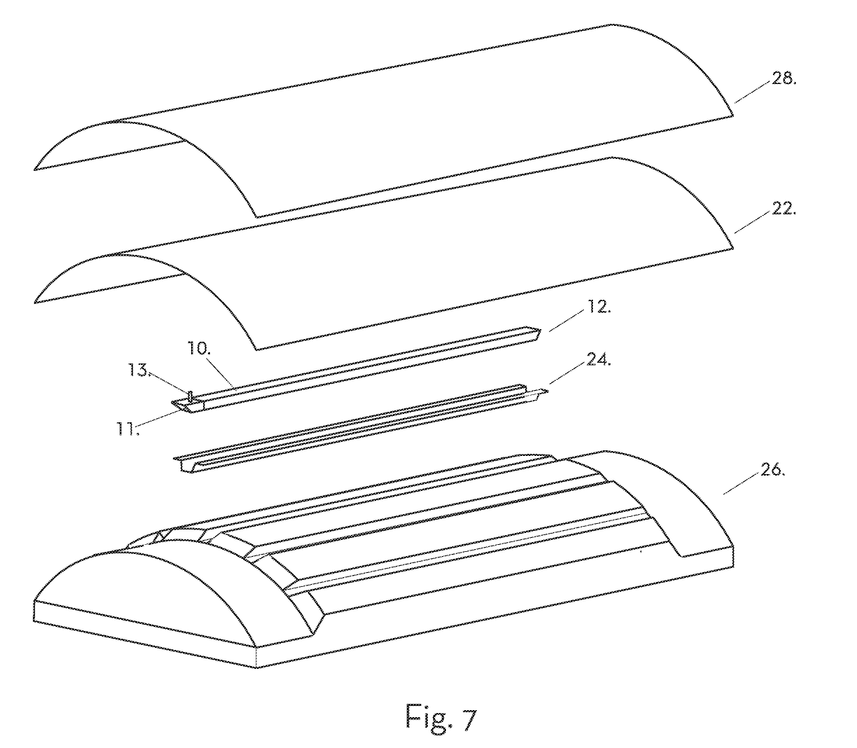

FIG. 7 is an exploded view of a typical hat stiffened panel layup and tooling stack-up using the embodiment of the present invention. Layup tool 26 can be a rigid metallic or carbon fiber/epoxy, and adapted to control the inside mold line of the composite panel. Carbon fiber layup 24 forms one of the hat stiffeners on the composite panel. Layup 24 is nested and compacted by the layup tool 26 with or without the mandrel 100 comprised of end caps 11 and 12, extruded portion 10 and vent tube 13 nested in a female type cavity. After the previous steps, composite skin 22 can be laid over the tool, hat section plies 24 and mandrel assembly 100. After the application of release films the caul sheet 28 can be placed over the stack, the vacuum bag can be applied over that, and the structure can be cured in an autoclave to form a composite material using the embodiments of the mandrel 100.

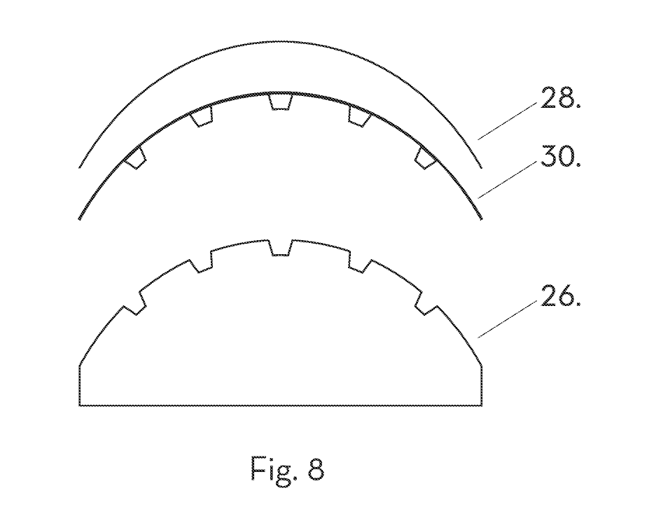

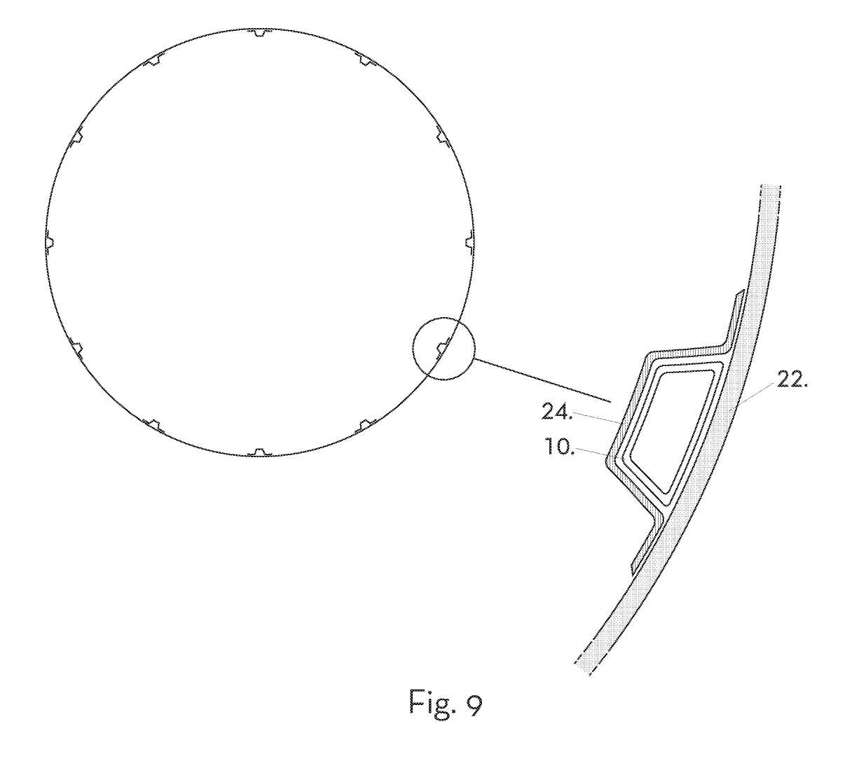

FIG. 8 is a sectional view of a hat stiffened panel representative of an airfoil skin or fuselage panel used for an airplane design. Layup tool 26 with a cured panel 30, and the caul sheet 28. Mandrel assembly is omitted for clarity from FIG. 8. FIG. 9 is yet another application of the present invention where it is used in the creation of a cured fuselage barrel. Mandrel 100 supports and applies autoclave pressure to adjacent plies in composite hat section layup 24 and composite skin layup 22. Layup tools and cauls sheets are omitted from FIG. 9 for clarity, but would be used in the embodiments of the present invention.

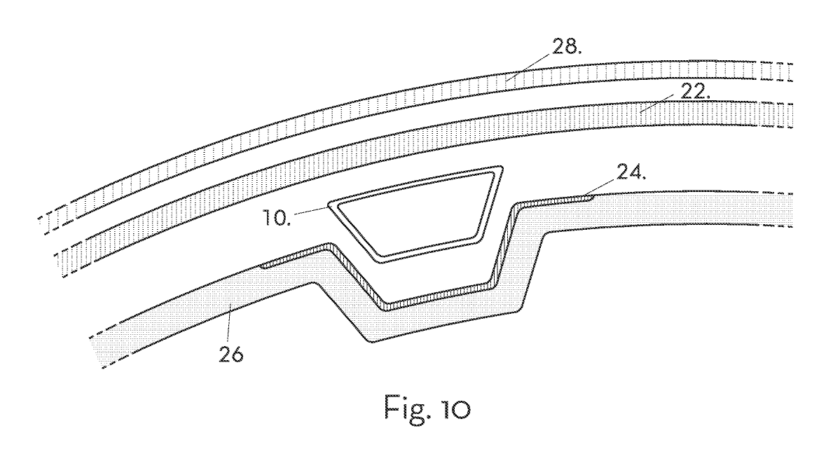

FIG. 10 is a close up cross section of the mandrel 100 as depicted in FIGS. 7, 8 and 9. Layup mold 26 is adapted to control the inside mold surface of the composite part being fabricated. Caul sheet 28 controls the outside mold surface. When vacuum bagged and autoclaved, caul sheet 28 exert pressure on skin layup 22 and the flanges of hat section layup 24 in contact with the skin 22. The hollow cavity formed by the hat section is filled by the extruded section 10. The extruded section 10 has autoclave pressure inside it, and in turn provides pressure against the skin laminate 22 and hat section laminate 24 that is common to the mandrel 100.

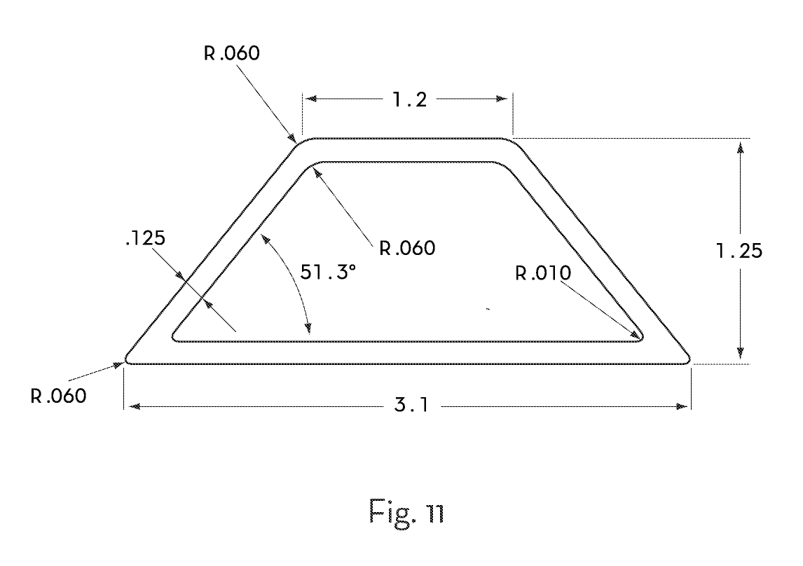

FIG. 11 is a dimensioned drawing of a typical mandrel section that would be used in the fabrication of large integrated composite structures. For example, a cross section of the extruded portion 10 is shown. The cross section is in a trapezoid shape. The base of the cross section is about 3 to about 4 inches long. In the embodiment shown the length of the base is about 3.1 inches long. The opposing side that is substantially parallel to the base is about 1.2 inches long. The height dimension defined by the distance between the base and the opposing side is about 1.25 inches. The two acute angles of the symmetrical trapezoidal shape are about 51.3° and the two obtuse angles of the trapezoidal shape are about 128.7°. The ends of the cross-sectional trapezoidal shape may be radiused to be 0.060 inches. The dimensions do not represent limits in any way to the size and shapes possible with the current invention. The width dimension may be from about 0.500 inches to about 6 inches or larger. Larger sizes may be achieved by using high capacity extrusion equipment.

A mandrel constructed by an embodiment of the present method can result in a semi-rigid, self releasing mandrel that can be used in any conventional composite manufacturing process. In another embodiment, the mandrel 100 can be partially collapsible by applying a vacuum to aid in extraction. The mandrel 100 offers the opportunity for recycling the polymers used in its construction.

The mandrel 100 constructed according an embodiment of the present invention can create various advantages due to its physical and chemical properties. For example, mandrel 100 as described above is self releasing, meaning it can have a surface tension of approximately between about 20 to about 30 dyne/cm. Depending on the grade of thermoplastic material used, the surface tension can be between about 22 to about 26 dyne/cm. Preferably, the surface tension is 24 dyne/cm. The surface tension also makes the mandrel difficult to contaminate. Moreover, because thermoplastic materials have a fairly high coefficient of expansion it shrinks during cool down, thus pulling away from the cured composite part and easing release from the manufactured composite.

Another advantage of using thermoplastic materials is for example, polymethylpentene is soft and conformable at composite cure temperatures and has much higher melting point. For example, embodiments of the thermoplastic materials used for the mandrel 100 may begin softening at temperatures between about 85° F. to about 120° F. Certain blends of polymethlpentene soften at about 91° F. or greater and may have a melting point of about 450° F. or greater. This allows the mandrel to conform to the composite part and apply uniform pressure to the part. The mandrel 100 can be softened to form other shapes besides the straight mandrel shown in FIGS. 1-12. Once softened between about 90° F. and about 300° F. the mandrel 100 may be bent using tools or other mandrels to form curved, circular or other irregular shapes.

The present invention may be embodied in other specific forms without deviating from the spirit or essential characteristics. The described embodiments are to be considered as illustrative and not restrictive. The scope of the invention is indicated by the appended claims and rather than the foregoing description. All changes which come within the meaning and range of equivalency of the claims are to be embraced within their scope.

1. A mandrel assembly comprising:
an elongated hollow portion comprising a thermoplastic material that is extrudable, the elongated hollow portion having closed ends; and
a vent tube connected to at least one closed end of the elongated hollow portion, the vent tube in air flow communication between an interior volume of the hollow portion and a volume outside the mandrel assembly.

2. The mandrel assembly of claim 1, wherein the elongated hollow portion has a first end; the mandrel assembly further comprising a first end cap attached to the first end.

3. The mandrel assembly of claim 2, wherein the first end cap has the vent tube attached to the first end cap, the vent tube extending from the first end cap.

4. The mandrel assembly of claim 1, wherein the elongated hollow portion has a second end; the mandrel assembly further comprising a second end cap covering the second end of the elongated portion to form an airtight seal.

5. The mandrel assembly of claim 1, wherein the mandrel assembly is adapted to shape and form a composite structure in an autoclave.

6. The mandrel assembly of claim 1, wherein the mandrel assembly is adapted to be used in fabrication of composite articles by fabrication techniques including fiber placement, tape laying, hand lay-up, resin infusion or resin transfer molding processes curable both in or out of an autoclave.

7. The mandrel assembly of claim 1, wherein the thermoplastic material is continuously extrudable.

8. The mandrel assembly of claim 1, wherein the hollow structure is formed of a single layer of thermoplastic material.

9. The mandrel assembly of claim 1, wherein the elongated hollow portion is self releasing with a surface tension of at least 24 dyne/cm.

10. The mandrel assembly of claim 1, wherein the elongated hollow portion becomes malleable at a temperature greater than 91° F.

11. The mandrel assembly of claim 1, wherein the thermoplastic material is Polymethylpentene.

12. A method for making a mandrel, the method comprising:
extruding a thermoplastic material to form an elongated hollow structure adapted to be used to fabricate composite articles in composite fabrication process.

13. The method of claim 12, further comprising continuously extruding the thermoplastic material.

14. The method of claim 12, wherein extruding comprises generating a single continuous layer of thermoplastic material.

15. The method of claim 12, further comprising providing a multi stage extrusion apparatus configured to form a single layer or a multilayer mandrel.

16. The method of claim 12, wherein the thermoplastic material is polymethylpentene.

17. The method of claim 12, wherein the composite fabrication process includes at least one of fiber placement, tape laying, hand lay-up, resin infusion or resin transfer molding processes.

18. A mandrel assembly comprising:
an elongated hollow structure comprising a thermoplastic material that is extrudable having a first end and a second end;
a first end cap attached to the first end;
a vent tube attached to the first end cap, the vent tube extending from the first end cap;
a second end cap attached to the second end;
the mandrel assembly adapted to shape and form a composite structure in an autoclave.
